(19) United States
(12) Patent Application Publication
(10) Pub. No.: US 2005/0138256 A1
(43) Pub. Date: Jun. 23, 2005

(54) Method and apparatus for processing hot key input using operating system visible interrupt handling

(76) Inventors: Frederick H. Bolay, Rancho Cordova, CA (US); Rajeev K. Nalawadi, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,491

(22) Filed: Dec. 23, 2003

(51) Int. Cl. G06F 13/24

(52) U.S. Cl. 710/260

(57) ABSTRACT

Embodiments include an interrupt handling system to generate an operating system visible interrupt such as a message signaled interrupt or interprocessor interrupt by an advanced configuration and power management interface (ACPI) and ACPI source language infrastructure. The interrupt handling system may be used to service hot keys. This interrupt handling system allows for easy upgrading of system functionality by updating a driver.

### BACKGROUND

1. Field

Embodiments of the invention relate to interrupt handling. Specifically, an exemplary embodiment related to an interrupt handling system using operating system visible interrupts.

2. Background

In a typical computer system, many devices are running concurrently such as storage drives, printers and human input devices. An interrupt system is used to efficiently utilize processor time and resources. When a device has information to be processed by a processor or an event occurs in the computer system an interrupt signal is generated. When the interrupt signal is received by the processor, the processor stops the execution of the currently running program and an interrupt handler is executed to service the device or event that generated the interrupt signal. When the device or event has been serviced the processor returns to the execution of the program that was interrupted.

A system management interrupt (SMI) is an operating system (OS) transparent interrupt, which may be generated by some devices or system events in a computer system. Servicing an SMI may generate some delay while executing the interrupt handler corresponding to the device or system event that generated the SMI. This may cause errors in the operating system (OS) upon return from the interrupt handler because the OS is unaware of the servicing of the interrupt but detects discrepancies caused by the delay in processing other programs while the CPU runs the interrupt handler such as gaps in time logs and similar problems.

A typical computer system often manages the power state (e.g., the level of power provided to or consumed by a device) and the configuration of devices attached to the system. An operating system running on the computer system may use an interface such as an advanced configuration and power interface (ACPI) to manage the power state and configuration of devices in the computer system. The ACPI provides a set of data structures and methods for an operating system to utilize when interfacing with the basic input output system (BIOS) and mainboard hardware necessary for implementing the configuration or power management.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a computer system implementing an improved interrupt handling system.

FIG. 2 is a flowchart of one embodiment of a process for improved interrupt handling.

FIG. 3 is a diagram of one embodiment of an interrupt handling table and description block.

### DETAILED DESCRIPTION

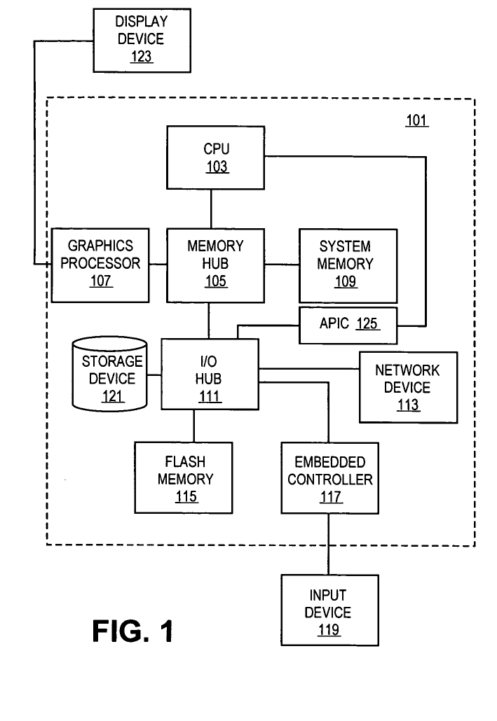

FIG. 1 is a diagram of one embodiment of a computer system. In one embodiment, computer system 101 may include a central processing unit (CPU) 103 to execute instructions. In another embodiment, computer system 101 may include multiple processors. CPU 103 may be located on or may be attached to a mainboard. In an embodiment with multiple processors, each processor may be located on or attached to the same mainboard or may be on separate mainboards. CPU 103 may be in communication with a memory hub 105 or similar device.

In one embodiment, memory hub 105 provides a communication link between CPU 103 and system memory 109, input-output (I/O) hub 111 and similar devices such as graphics processor 107. In one embodiment, memory hub 105 may be a ‘North Bridge’ chipset or similar device.

In one embodiment, system memory 109 may be a random access memory (RAM) module or set of modules. In one embodiment, system memory 109 may be synchronized dynamic random access memory (SDRAM), double data rate (DDR) RAM or similar memory storage devices. System memory 109 may be used by computer system 101 to store application data, configuration data and similar data. System memory 109 may be volatile memory that loses data when computer system 101 powers down.

In one embodiment, other devices may be connected to memory hub 105 such as a graphics processor 107. Graphics processor 107 may be located directly on the mainboard. In another embodiment, graphics processor 107 may be located on a separate board attached to the mainboard through an interconnect or port. For example, graphics processor 107 may be located on a peripheral card attached to the mainboard through an advanced graphics port (AGP) slot or similar connection. A graphics card or graphics processor 107 may be connected to a display device 123. In one embodiment, display device 123 may be a cathode ray tube (CRT) device, liquid crystal display (LCD), plasma device or similar display device.

In one embodiment, memory hub 105 may be in communication with an I/O hub 111. I/O hub provides communication with a set of I/O devices and similar devices such as storage device 121, flash memory 115, embedded controller 117, network device 113 and similar devices. In one embodiment, I/O hub 111 may be a ‘South Bridge’ chipset or similar device. In another embodiment, memory hub 105 and I/O hub 111 may be a single device.

In one embodiment, an advanced programmable interrupt controller (APIC) 125 may be in communication with I/O hub 111 and CPU 103. APIC 125 is a device that may handle interrupts from and for multiple CPUs. APIC 125 may be connected to additional devices that may be the ultimate source of an interrupt. APIC 125 may pass these interrupt requests on to I/O hub 111 or directly to CPU 103.

In one embodiment, storage device 121 is a non-volatile storage device such as a fixed disk, physical drive, optical drive, magnetic drive or similar device. Storage device 121 may be used to store application data, operating system data and similar system data. In one embodiment, flash memory 115 may store system configuration information, BIOS data and similar information. Flash memory may be an EEPROM, battery backed up memory device such as CMOS or similar non-volatile storage system.

In one embodiment, an embedded controller may be connected to I/O hub 111. An embedded controller 117 is a type of microcontroller that performs complex low level operations in computer system 101. In one embodiment, embedded controller 117 may function as an input device controller serving as an interface between computer system 101 and an input device 119. In an exemplary embodiment, the embedded controller may function as a keyboard controller and receive scan codes as input from a keyboard.

In one embodiment, other devices such as a network device 113 may be in communication with I/O Hub 111. Network device 113 may be a modem, network card, wireless device or similar device. In one embodiment, network device 113 is integrated into the mainboard. In another embodiment, network device 113 is a peripheral card connected to the mainboard through a Peripheral Card Interconnect (PCI) slot or similar interconnect.

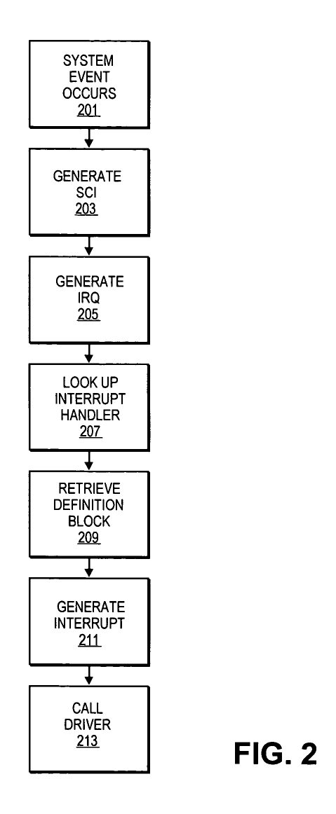

FIG. 2 is a flowchart of one embodiment of a process for the operation of improved interrupt handling. In one embodiment, the improved interrupt handling is triggered when a system event occurs that must be serviced (block 201). In one embodiment, the system event is the reception of input from a human input device (HID) such as a keyboard, mouse or similar input device. For example, a user may utilize a keyboard to input a ‘hot key’ or set of hot keys. In one embodiment, a hot key or set of hot keys may be a single key input or a set of key inputs. Hot keys may be used to initiate a specific function of the computer system. For example, the combination of the control key (CTRL), alternate key (ALT), shift key (SHIFT) and function 7 key (F7) may be used in some computer systems to switch the display output from an attached display to an external display in laptop systems. Other example hot key combinations include CTRL+ALT+SHIFT+F4 to initiate a suspend or standby state for a computer system, and CTRL+ALT+SHIFT+F3 to initiate a hot swap of a device such as PC cards.

In an exemplary embodiment, a user may initiate a display switch by pressing the CTRL+ALT+SHIFT+F7 keys on an input device 119 such as a keyboard. The keyboard sends a set of signals to embedded controller 117 which are interpreted as a scan code or set of scan codes. A scan code is a digital encoding of a keystroke or keystroke combination.

In one embodiment, after a system event is detected a system control interrupt (SCI) is generated by the detecting or generating device (block 203). SCIs may be used to notify the operating system of system events. SCIs are active, low, shareable, level interrupts. In an exemplary embodiment, when an embedded controller 117 detects a scan code or set of scan codes for a hot key received from keyboard 119, embedded controller 117 may generate an SCI. The SCI may be sent to I/O hub 111.

In one embodiment, I/O hub 111 may detect an SCI and generate an interrupt request (IRQ) that may be sent to the CPU through memory hub 105 (block 205). In one embodiment, there may be fifteen discrete IRQ designations (e.g., 0 through 15). An interrupt controller may support two or more modes of operation. A first mode may support fifteen IRQ designators. For example, an APIC with an 8259 PIC mode. A second mode may support a larger number such as 255. For example, an APIC may support 255 IRQ designations. In an exemplary embodiment, I/O hub 111 may receive an SCI from embedded controller 117 and generate an IRQ based on the source of the SCI. For example, keyboard generated SCIs may be assigned to IRQ2 or an SCI including an embedded controller source may be assigned to IRQ9.

In one embodiment, when CPU 103 receives the IRQ an interrupt handling table may be used to determine an interrupt handler for the incoming IRQ (block 207). In one embodiment, an interrupt descriptor table (IDT) points to the location of a first interrupt handler associated with the IRQ line or priority number. An interrupt handler may be a program that services a particular type of interrupt, or a particular interrupt source, such as a keyboard or other device.

In one embodiment, SCI are level triggered interrupts. Level triggered interrupts may share an IRQ with multiple devices. A chain of interrupt handlers may be used to determine the type of interrupt that is requesting service. Each interrupt handler checks if its source type needs service then passes control to the next interrupt handler in the chain until the interrupt is cleared.

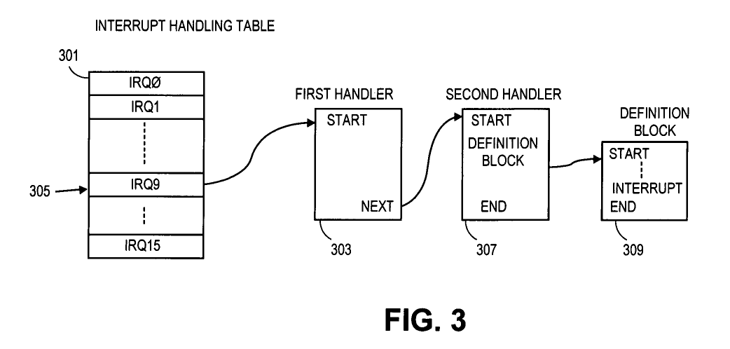

FIG. 3 is a diagram of one embodiment of an interrupt handling system. In the exemplary interrupt handling system, the CPU upon receiving an interrupt may use IDT 301 to find a pointer 305 corresponding to an incoming IRQ line or priority number. Pointer 305 may indicate a first interrupt handler 303. An IRQ line or number may be used by multiple devices. The interrupt handlers for each mechanism sharing the line or number may be linked together. For example, if first interrupt handler 303 does not correspond to the device or source of the interrupt then a second interrupt hander 307 is called. The CPU may start at the first interrupt handler in a linked list or set of interrupt handlers and progress to a next interrupt handler when it determines that the current interrupt handler does not service the current interrupt type or source.

In one embodiment, an interrupt handler may be found to service the interrupt request. The interrupt handler may include a pointer to a definition block 309 corresponding to the device or the source of the interrupt (block 209). This definition block 309 may contain information relating to hardware implementation and configuration details in the form of data and control methods. The control methods may be in ACPI source language (ASL) code that enable an operating system to manage the settings such as speed, size, power state and similar configuration details of a device.

In an exemplary embodiment, second interrupt handler 307 may be a device driver for embedded controller 117. The embedded controller interrupt handler may make a determination of the source of input. Based on the source of the input a definition block 309 may be utilized. For example, if a hot key generated the interrupt, then the embedded controller interrupt handler determines the appropriate definition block 309 for handling keyboard input, hot keys or the specific hot key. Definition block 309 may include a set of data structures and methods to service the interrupt request. Definition block 309 may be software implemented at a firmware level. Firmware in this context is low level software outside the control of the OS. The servicing of the interrupt by definition block 309 may include the generation of another interrupt (block 211). In an exemplary embodiment, the retrieval of definition block 309 utilizes an advanced configuration and power interface (ACPI) driver. Definition block 309 may be in part a differentiated system definition table (DSDT), secondary system description table (SSDT) or similar structure.

In one embodiment, an interrupt is generated by definition block 309 using a message signaled interrupt (MSI), intraprocessor interrupt (IPI) or similar OS visible interrupt. In one embodiment, ACPI source language (ASL) code in definition block 309 may generate the OS visible interrupt. OS transparent interrupts such as system management interrupts (SMI) cause problems for an OS when used. Servicing an SMI may generate some delay while executing the interrupt service routine. This may cause errors upon return from the interrupt handler because the OS is unaware of the servicing of the SMI but detects discrepancies caused by the delay in executing the interrupt service routine such as gaps in time logs and similar problems.

In one embodiment, an MSI may be triggered by a write to a specific area of memory by definition block 309. The data identifying the type of interrupt may be written to the specified memory address. The use of an MSI has the advantage of being OS visible so that latency in servicing the MSI does not cause coherency problems. In another embodiment, an interprocessor interrupt (IPI) may be generated. An IPI may be used in a multiprocessor environment. IPIs allow a processor to send an interrupt to another processor or set of processors.

In an exemplary embodiment, definition block 309 defines the memory mapped address into which an MSI or IPI writes to cause an interrupt and the space where the system event data is stored. For example, the stored data may be the address where hot key data has been collected. An exemplary implementation in ACPI source language (ASL) for defining the memory space for use with servicing hot key input may be:

| OperationRegion(MSIS, SystemMemory, 0xFEC01000,0x8) | |
|---|---|
| Field (MSIS, AnyAcc, Lock, Preserve) | |
| { | |
| Offset(0), // Dynamic Values | |
| MSIA, 32, | // Memory mapped address for MSI |
| | // delivery |
| IPIM, 32, | // Memory mapped address for IPI delivery |
| SCAN, 8 | // Scan code for hot key |
| } | |

In an exemplary embodiment, the ASL for the control method to service hot key input may be implemented as:

| Method(_Q52) // Hot key event | |
|---|---|
| { | |
| if(LEqual(SCAN, 0x41)) { | // Test if scan code is |
| | // CTRL+ALT+SHIFT+F7 |
| // Additional codes may be covered as well | |
| if(MSIM) { // Test if MSI are used | |
| Store(0x20,MSIA) // Make memory write at MSI address | |
| | // to initiate the execution of an |
| | // ’interrupt type 20’ handler |
| } | |
| else { | |
| Store(Data1,IPIM) | // Make memory write that causes |
| | // IPI and execution of appropriate |
| | // interrupt handler |
| }}} | |

In one embodiment, after the MSI or IPI is generated an appropriate driver may be determined by the OS (block 213). The driver may then complete the servicing of the interrupt by handling the original system event. As used herein, a driver may be software for controlling and managing a computer system component at an OS level. Software at the OS level is managed by the OS. For example, the device driver for a hot key may instruct graphics card 107 to disable the output to an attached display device 123 and enable the output to a external display device.

In one embodiment, the improved interrupt handling system may provide improved responsiveness for system events because an MSI or IPI are edge triggered, each having its own entry in an interrupt handling table. The functionality of computer system 101 may be more easily updatable because the driver that provides the additional functionality can be updated or newly installed. Updating of BIOS or firmware, for example for updating SMI handling, may not be necessary. The use of an OS visible interrupt and driver allows for construction of general driver functionality and standardization of functionality independent of firmware and BIOS. For example, new hot key functionality or combinations may be implemented by an update of the hot key driver. The improved interrupt handling system may be used in computer systems where use of OS transparent interrupts such as SMI are restricted or limited.

In one embodiment, the improved interrupt handling system may be implemented in software and stored or transmitted in a machine-readable medium. As used herein, a machine-readable medium is a medium that can store or transmit data such as a fixed disk, physical disk, optical disk, CDROM, DVD, floppy disk, magnetic disk, wireless device, infrared device, and similar storage and transmission technologies.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

1. An apparatus comprising:
a device to generate an interrupt to service a system event;
a processor to execute an interrupt handler for the interrupt to generate an operating system visible interrupt to be handled by a device driver that services the system event from the device; and
a storage device having stored therein the device driver.

2. The apparatus of claim 1, wherein the device comprises an embedded controller coupled to a peripheral input device.

3. The apparatus of claim 1, further comprising:
an interrupt controller to generate an interrupt to trigger the interrupt handler.

4. The apparatus of claim 1, wherein the interrupt handler includes a definition block and an advanced configuration and power interface method.

5. The apparatus of claim 1, further comprising:
a memory device coupled to the processor to store a definition block.

6. A method comprising:
detecting a system event;
generating an operating system visible interrupt by a method in a definition block for an interrupt source; and
servicing the interrupt by a driver.

7. The method of claim 6, wherein the interrupt is one of an message signaled interrupt (MSI) and an interprocessor interrupt (IPI).

8. The method of claim 6, further comprising:
generating a system control interrupt (SCI).

9. The method of claim 8, wherein the system control interrupt source is an embedded controller.

10. The method of claim 6, further comprising:
determining an interrupt handler for the system event.

11. The method of claim 6, wherein the system event is a hot key input.

12. The method of claim 10, further comprising:
executing a definition block to generate the operating system visible interrupt.

13. An apparatus comprising:
means for generating a first interrupt;
means for generating a second interrupt based on the first interrupt; and
means for executing a driver to service the second interrupt.

14. The apparatus of claim 13, further comprising:
means for storing the driver.

15. The apparatus of claim 13, further comprising:
means for storing a definition block.

16. The apparatus of claim 13, further comprising:
means for retrieving a definition block.

17. A system comprising:
a processor to execute a driver;
a bus coupled to the processor;
a first memory device coupled to the bus to store a driver;
a second memory device coupled to the bus to store a definition block that triggers the driver;
an input device; and
a network interface controller.

18. The system of claim 17, further comprising:
a controller to generate a first interrupt when input is received by the input device.

19. The system of claim 17, further comprising:
a second processor to generate an interrupt.

20. A machine readable medium having instructions stored therein which when executed cause a machine to perform a set of operations comprising:
generating a first interrupt for a system event to be serviced at the firmware level;
generating a second interrupt at the firmware level to be service at the operating system level; and
servicing the system event at the operating system level.

21. The machine readable medium of claim 20, having further instructions therein which when executed cause a machine to perform a set of operations comprising:
executing a driver.

22. The machine readable medium of claim 20, wherein a definition block handles the first interrupt at the firmware level.
